(19) United States
(12) Patent Application Publication
(10) Pub. No.: US 2015/0120471 A1
(43) Pub. Date: Apr. 30, 2015

(54) Systems Methods and Devices for Generating Secure Electronic Authorization and Payment Processing

(71) Applicants: Laurence Cooke, Toronto (CA); Melissa Gallo, Toronto (CA); Hilton McGough, Habach (DE)

(72) Inventors: Laurence Cooke, Toronto (CA); Melissa Gallo, Toronto (CA); Hilton McGough, Habach (DE)

(21) Appl. No.: 14/521,496

(22) Filed: Oct. 23, 2014

Related U.S. Application Data
(60) Provisional application No. 61/895,442, filed on Oct. 25, 2013.

(51) Int. Cl. G06Q 20/32; H04B 5/00

(52) U.S. Cl. CPC G06Q 20/3224; G06Q 20/3278; H04B 5/0031
USPC 705/16; 705/41; 705/44; 455/41.1

(57) ABSTRACT

The present invention provides a unique way of using mobile or other devices containing accelerometers to provide a unique two-factor authentication comprising something possessed and something known. This involves a combination of the device and the user in the authentication. In one embodiment, the user adds a unique movement pattern (something known) to the device ID (something possessed) to create a unique two-factor authentication. In this way, authentication and security are taken to a high level, beyond biometric identification which is actually just two things possessed.

### RELATED APPLICATIONS

The present application is a nonprovisional filing of provisional application Ser. No. 61/895,442, filed on Oct. 25, 2013. Priority is claimed to said provisional application. The full specification and claims thereof are hereby incorporated herein by reference

### BACKGROUND OF THE INVENTION

Credit cards, debit cards, gift cards, and other financial cards and presentation instruments are widely used by consumers as a convenient way to conduct financial transactions. Such cards and their associated accounts have been made even more convenient with the introduction of wireless devices that store and use account information or identification. Mobile phones, PDAs, key fobs and other devices incorporate features using RFID (Radio Frequency ID) or NFC (Near Field Communications) signaling to permit a cardholder to conduct a transaction by placing the device near an RFID reader, e.g. at a retail POS system at a merchant location.

Unfortunately, presentation instruments built into wireless or other mobile devices have increased the risk of fraudulent transactions and the underlying transaction has the same risk as with a swipe transaction. Chip and PIN use has improved the situation, providing two-factor authentication but this technology is not easily adaptable to the use of mobile devices. As an example, when a mobile phone employing RFID or NFC features is used by a consumer, the user places the phone near a reader, and after the reader at the POS system identifies the user and initiates a transaction, the user is typically not required to enter a PIN (personal identification number). Part of the security of such devices is that the information they contain can only be read from very close proximity. Unfortunately, thieves have devised various means to steal credit card primary account number (PAN) information, by using a loop antenna to remotely read all the credit card information. With credit card PAN information, name and expiry date, thieves can create fraudulent magnetic stripe-based credit cards that work wherever chip and PIN authentication is not deployed. There are more secure arrangements possible, but such systems are rarely used.

Current implementations of digital wallets rely on a specialized smart phone and SIM card, which contains a near field communication (NFC) chip to store payment instrument information or rely on a special wireless provider's SIM card. This puts an unnecessary burden on consumers, distributors, and carriers to have to use expensive equipment or rely on a service provider, as well as on the merchants to install readers that accept payment using NFC. If the consumer chooses not to buy a special smart phone with NFC, then they are not able to take advantage of the benefits of a digital wallet. Use of NFC also limits consumer choice of phone providers, requiring that the user's NFC provider and phone provider have an agreement in place. Even phones with NFC chips require a mobile wallet application and a secure storage solution (usually on the SIM card). Most SIM cards today do not allow a third party to access the SIM and as such only the operator can really provide a SIM-based solution. Operators also have to upgrade both the SIM card and the applications that control the SIM card to allow it to hold credit card information. This is expensive and time consuming.

Smartphones can be hacked and if the smart phone is lost or stolen, then all the stored electronic payment information could be available to whoever stole or recovered the phone. Other payment solutions are also highly insecure. Cloud-based solutions use static 2D or QR codes to exchange information, and such codes are easily pirated, for example by taking a picture over a user's shoulder. The perpetrator can then use the picture to conduct fraudulent transactions.

As can be seen, there is a need for an improved payment system for conducting secure transactions.

A technology called “Bump” provides a method for pairing wireless devices without the need for the user to enter a PIN of passcode. There are two main parts to the Bump technology: an application running on a Bluetooth device or utilizing a wireless network device and a matching algorithm running on a server in a network. The wireless devices are equipped with the Bump application and use sensors to detect and report the bump to the network server. The network server then matches two phones that detect the same bump. The network server uses a complex filtering scheme based on the location of the devices and characteristics of the bump event to match the devices. While the Bump technology simplifies pairing from the user perspective, it requires two mobile devices with accelerometers both with access to use the Bump technology for pairing. The Bump technology also requires the exchange of information between the two mobile devices. When Bump technology is used on existing payment systems, the “bump” of the devices initiates the exchange of information and brings the user's devices into contact with the devices of numerous unknown and potentially risky vendors.

Accordingly, there remains a need for mechanisms that simplify the payment process from the user perspective without requiring additional hardware.

### SUMMARY OF THE INVENTION

Devices, methods, and systems related to portable electronic devices and authentication, payment processing systems, and systems and methods for using motion sensor data alone or in combination with a static identifier or other authentication methods are described.

### DETAILED DESCRIPTION

Although illustrative implementations of various embodiments are provided below, the disclosed devices, systems and methods may be implemented using any number of techniques, whether currently known or in existence. The disclosure should in no way be limited to the examples and techniques provided herein, but may be modified within the scope of the appended claims along with their full scope of equivalents.

The present invention provides a unique way of using mobile devices containing accelerometers to provide a unique two-factor authentication comprising something possessed and something known. This involves a combination of the device and the user in the authentication. In one embodiment the user adds a unique movement pattern (something known) to the device ID (something possessed) to create a unique two-factor authentication. In this way, authentication and security are taken to yet another level, even beyond biometric identification which is actually just two things possessed.

The instant invention encompasses a variety of uses for movement data utilizing a mobile device. Movement data can be used as a confirmation; for example, as an alternative to pressing a button for example. Movement data can be used to authenticate; as an alternative to a personal identification number (PIN) or as a signature. Movement data can be used directly or indirectly to generate a single-use credential or “PIN”; for example to verify that the correct parties are peered or connected. Movement data can also be used during a transaction process to initiate or confirm other processes. For example, the generation of movement data can be used to indicate the need for a PIN from a remote system in order to ensure the correct parties are peering or connecting. One of the key advantages of the use of movement data in the methods of the application is that different pre-defined movements can be associated with different outcomes or functions; for example, one movement can place a bet and another can open a door. Thus, the two-factor authentication can utilize different movements to initiate or confirm different functions.

The present invention also encompasses single-use tokens. Such tokens can be used to identify transacting parties and also to initiate a transaction. Such tokens can be generated by a mobile device or remotely from a mobile device and used to carry only the transaction-specific data. For example, a single-use token may comprise a large identifier (preferably a sixteen digit or larger number) associated with a user's name and the amount of the transaction. No other data needs to be associated with the token in order to complete a transaction. In some embodiments of the present invention, the parties to the transaction may have as little information as the amount of the transaction and still be able to securely complete the transaction. Single-use tokens have enormous security advantages in that they allow parties who do not want to share private information to interact in a secure manner without fear of fraud or theft.

One skilled in the art will immediately recognize that all of these aspects of the present invention can be used individually or combined in various permutations and in novel ways to form the various embodiments encompassed by the invention.

In one embodiment, devices and methods for generating a device and user specific authentication means is provided that does not require a user's memory and is not susceptible to theft. In this embodiment, an authentication means is generated through the utilization of data provided by a motion-sensing device or motion-sensing component in combination with a unique static identifier for a specific electronic device. For example, the unique static identifier may comprise a device's Subscriber Identity Module (SIM), International Mobile Station Equipment Identity (IMEI), or universally unique identifier (UUID).

The motion-sensing component can be operative to detect movement of an electronic device. In some embodiments, the motion-sensing component can provide an output describing the movement of the device relative to the environment (e.g., the orientation of the device, or shaking or other specific movements of the device by the user). The motion-sensing component can include any suitable type of sensor for detecting the movement of device. By way of non-limiting example, the motion-sensing component can include one or more three-axis acceleration motion-sensing components (e.g., an accelerometer) operative to detect linear acceleration in three directions (i.e., the x or left/right direction, the y or up/down direction, and the z or forward/backward direction). As another example, the motion-sensing component can include one or more two-axis acceleration motion sensing components which can be operative to detect linear acceleration only along each of x or left/right and y or up/down directions (or any other pair of directions). In some embodiments, the motion-sensing component can include an electrostatic capacitance (capacitance-coupling) accelerometer that is based on silicon micro-machined MEMS (Micro Electro Mechanical Systems) technology, a piezoelectric type accelerometer, a piezoresistance type accelerometer, or any other suitable accelerometer. In some embodiments, the motion-sensing component can include one or more rotational sensors (e.g., a gyroscope). The data provided by the motion-sensing device can include the amplitude and wavelength of the motion.

Communications between computers implementing embodiments can be accomplished using any electronic, optical, radio frequency signals, or other suitable methods and tools of communication in compliance with known network protocols.

The portable electronic device may be any of a variety of devices including but not limited to a mobile phone, a personal digital assistant (PDA), a laptop computer, a tablet computer, a key fob, or other portable electronic device.

In another embodiment, a portable electronic device is disclosed. The portable electronic device comprises a contactless communication transceiver configured to provide information to an input device configured to receive inputs, an accelerometer, and a processor. When a user moves the portable electronic device the accelerometer measures the movement and provides one or more movement values. In one embodiment the movement values are combined with a static identifier or “device value” unique to the electronic device to generate a two-factor (user (known) and device (possessed) specific) electronic identifier. In other embodiments, the movement values are used to initiate an action or other response to such movement values.

In another embodiment, a method of activating a remote application is disclosed. The method comprises transmitting movement data from a portable electronic device to selectively activate a second device receiving the activation input. For example, movement data can be used to unlock a door, launch a software application, open a garage, start a car, or log on to a computer. In this embodiment the movement can be generated by the user's hand movement, the user's stride, by the movement of a bicycle, or by the movement of a car such that the user does not have to hold the device in his or her hand.

In another embodiment, multiple movement authentications may be created for each portable electronic device. In this embodiment each movement value can be associated with different activities requiring authentication. A user can generate unique movement data through the use of different movements in association with different desired results. By way of non-limiting examples, shaking the motion sensor up and down may be used for opening a garage door, a throwing motion may be used to place a bet, and moving the motion sensor from side to side could provide movement authentication for starting a car or authenticating a transaction. In fact, any movement as defined by the user can be used in this embodiment. One skilled in the art will immediately understand the many possible uses of said movement-based authentication.

In another embodiment, the present invention provides a novel form of electronic wallet application, also referred to as an eWallet, which provides a variety of financial and payment capabilities. The electronic wallet application supports paying for products or services with the device in much the same way as presenting a credit card, a debit card, or a transit card for payment. In an additional embodiment, a method of completing a transaction is disclosed. The method comprises receiving a first input to select one of a plurality of payment means for payment transfer, the payment means provided by an electronic wallet application. The method also comprises launching the electronic wallet application on the portable electronic device, the electronic wallet application configured to provide access to the payment transfer information of the selected payment means. The method further comprises transmitting the payment transfer information to a point-of-sale terminal, wherein the transmitting is performed using contactless communication and authenticated using movement authentication.

In another embodiment, the movement authentication comprises an electronic payment credential. In this embodiment, methods for securely authorizing a financial transaction utilizing said electronic payment credential are disclosed. For example, the electronic payment credential can comprise a credential representing a pre-paid account such as a gift card or other account. According to one embodiment, a method of authorizing a financial transaction utilizing an electronic payment credential can comprise maintaining information identifying an account associated with the electronic payment credential. The information can also identify multiple device specific payment credentials so that one or more electronic devices are authorized to conduct financial transactions. A request to authorize the transaction can be received. The request can include the electronic payment credential. The transaction can be authorized based at least in part on the information identifying the account. Authorizing can comprise determining that the electronic payment credential is one authorized to use the account.

According to another embodiment, a system for authorizing a financial transaction utilizing a movement authentication as an electronic payment credential can comprise a mobile electronic device adapted to maintain or create the electronic payment credential and initiate the financial transaction utilizing the electronic payment credential. The electronic payment credential can include a single-use identifier. The system may include a point-of-sale device and the mobile electronic device can initiate the financial transaction by presenting the payment credential to the point-of-sale device. In a more preferred embodiment the mobile device and the point of sale device can each present the payment credential to a third party payment or acquirer system. The electronic payment credential can comprise, for example, a credential representing a pre-paid account such as a gift card or other account such as a bank account or credit card information. The system can also include an acquirer system adapted to maintain information identifying an account associated with the electronic payment credential. The information can identify one or more authorized electronic payment credentials. The acquirer system can receive a request to authorize the transaction, for example via the point-of-sale device. The request can include the electronic payment credential initiating the financial transaction. The acquirer system can authorize the transaction based at least in part on the information identifying the account. Authorizing can comprise determining that the electronic payment credential initiating the transaction is one of the authorized electronic payment credentials.

According to yet another embodiment, a machine-readable medium can have stored thereon a series of instructions which, when executed by a processor, cause the processor to authorize a financial transaction utilizing an electronic payment credential by maintaining information identifying an account associated with the electronic payment credential, receiving a request to authorize the transaction, wherein the request includes information identifying an electronic payment credential, and authorizing the transaction based at least in part on the payment credential. For example, the electronic payment credential can comprise a credential representing a pre-paid account such as a gift card account.

The numerous benefits of the use of a movement authentication as an electronic payment credential will be immediately evident to one skilled in the art. Such benefits include but are not limited to the inability of an observer to easily duplicate and steal a user's movement authenticator.

In an additional embodiment of the invention, systems, devices, and methods for achieving secure, wireless, touch-free, peer to peer connection are provided. In this example, two or more devices communicate in a peer-to-peer fashion. A first accelerometer-containing device is moved in a pre-defined way. The movement generates a unique single-use identifier and the first device broadcasts this number. A second device is moved in a pre-defined way or, if it does not contain an accelerometer or is stationary, is otherwise placed in a state to receive the unique single-use identifier from the first device. The users of the devices confirm that the single-use identifier is the same on each device and thus confirm the interaction between the devices. In this embodiment, the devices may optionally contain a locator means such as a global positioning system (gps) device.

In a further embodiment of the peer-to-peer connection system of the invention, the devices to be connected are running the same payment application in communication with a third party transaction processor. The user of a first device chooses a payment method account, such as a credit card, bank account, gift card, etc., and a payment amount and moves the device in a pre-defined way in order to generate and broadcast a single-use identifier number. A second device is moved in a pre-defined way or otherwise placed in a position to receive the single-use identifier number and the payment amount. The users confirm (for example verbally) that the single-identifier number is the same number on both devices and take an action on their devices, such as pressing a software button (by way of non-limiting example the button may be “OK”). The action initiates the transmission of information to said third party transaction processor. The information may comprise the payment method account, the payment amount and the single-user identifier from the first device and the payment amount, the single-user identifier, and optionally a specific deposit account from the second device. The transaction processor uses the single-user identifier to match the two users and transfers the payment amount from the payment method account chosen by the user of the first device to the payment deposit account of the user of the second device. Thus, a transaction takes place with no information shared between the users other than the single-use identifier code and the payment amount of the transaction.

In a further variation of the peer-to-peer connection system according to the invention, two or more devices communicate in a peer-to-peer fashion. For example, the devices may run the same payment application in communication with a third party transaction engine. The transaction engine may carry out many functions including facilitating transactions. The user of a first accelerometer-containing device may choose a payment method, such as a credit card, bank account, gift card, rewards account, etc., and a payment amount and move the device in a pre-defined way in order to initiate an application on the transaction engine as a Payer. A second device may be moved in a pre-defined way or otherwise placed in a position that indicates readiness to act as a Payee to the transaction engine. The transaction engine attempts to match the time of the initial movement of the first device and the location of the first device with a likely second device based on the time and location data. If a suitable match is found, the transaction engine generates a single-use identifier and transmits the identifier to all of the devices. The users of the devices confirm that the single-identifier number is the same number and take an affirmative action on their devices, such as pressing a software button. Based on the affirmative action, the transmission engine generates a first token which may contain the amount of the transaction, the identity of the Payer and the identity of the Payee, the value to be transferred as well as any other desired information. This token will preferably be a single-use token which itself is associated with a permanent token. Alternatively the first token may be a permanent token. The first token or the permanent token may be used directly to complete the desired transaction or may be transmitted by the transaction engine to a third party for the completion of the transaction. In another embodiment of the foregoing systems, where the single-use identifier cannot be received by the second device or matched by the transaction engine, the users of the devices can pick a value to act as the single-use identifier.

In another variation of the peer-to-peer connection system of the invention, the movement of a first accelerometer-containing device generates a single-use token directly or by request from a transaction engine. This token contains, for example, the payment amount, and may be associated by the transaction engine with information of the user of the first device. Such information can comprise payment account information, a permanent token, or other desired information. The user of the second device reads the single use token and transmits it to the transaction engine. The transaction engine matches the token information received from the two devices and completes the transaction. In this example, the single-use token may be represented by a bar code.

In a variation of the foregoing peer-to-peer connection systems, there can be multiple payers and/or multiple payees. This variation can involve multiple Payers. The transaction engine matches multiple Payers based on time and location and transmits the single-use identifier to each Payer device as well as the Payee. In this example, a convenient method of splitting and paying a bill or invoice is provided.

Also, techniques, systems, subsystems and methods described and exemplified in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and can be made without departing from the spirit and scope disclosed herein.

In order to illustrate the present invention, reference is made to the following non-limiting examples. While several embodiments have been provided in the present disclosure, it should be understood that the disclosed systems and methods may be embodied in many other specific forms without departing from the spirit or scope of the present disclosure. The present examples are to be considered as illustrative and not restrictive, and the invention is not to be limited to the details given herein. For example, the various elements or components may be combined or integrated in another system or certain features may be omitted, or not implemented.

### EXAMPLES

### Example 1

In a non-limiting example of the invention, a payment system, methods and devices for payment transactions are provided. In this example, a system is provided whereby a customer carrying a mobile device comprising an accelerometer places an order with the provider of a good or service where the customer has a pre-existing payment account (which can be a direct account, a credit card, a gift card, or a link to a bank account etc.) using his device from a remote location. When the customer arrives at the good or service delivery location his device is automatically recognized remotely, for example by gps or wifi connection, and a notification of the customer's presence is indicated on the provider's point of sale device. The provider pushes a button or otherwise initiates a request for payment that is sent to the customer's mobile device. The customer moves the mobile device in a predetermined pattern, the mobile device detects the accelerometer movement or pattern and sends a positive response to the provider's request for payment. The provider's system initiates a transfer from the customer's account to the provider's account and the customer is provided with the goods or services. If the customer fails to respond to the request for payment the transaction may be cancelled.

### Example 2

In a further non-limiting example of the payment system of Example 1, the customer and provider can establish a pre-defined transaction so that the customer is not required to place an order or initiate a transaction. Instead, the customer's pre-defined transaction is initiated when the customer's device is detected, for example by gps or wifi, in the proximity of the provider.

### Example 3

In a further example of the payment system of Example 1, the pre-defined transaction is initiated by a system to detect the customer's automobile. In one example of this preferred embodiment, a scanner reads the license plate of the customer's automobile and initiates a transaction which is completed as above using the customer's mobile device.

### Example 4

In a further non-limiting example of the invention, a peer-to-peer payment system, methods and devices for payment transactions are provided. In this example, a system is provided whereby multiple customers carrying mobile devices each comprising an accelerometer and optionally a gps device (the “Customer Devices”) wish to jointly pay an invoice to a merchant or service provider (the “Merchant”). The Customer Devices may be running the same payment application in communication with a third party transaction engine (the “Transaction Engine”). The customers may each choose a payment method, such as a credit card, bank account, gift card, rewards account, etc., and a payment amount and each customer moves his or her respective Customer Devices in a way that has been pre-defined by each customer, in order to initiate an application on the transaction engine as a Payer. The Transaction Engine records the time and location of the movement of the Customer Devices. The Merchant may also have a device running a payment application in communication with the Transaction Engine (the “Merchant Device”). The Merchant Device may be moved in a pre-defined way or otherwise placed in a position that indicates readiness to act as a Payee to the Transaction Engine. The Transaction Engine attempts to match the time of the initial movement of the Customer Devices and the location of the Customer Devices with a likely Merchant Device based on the data it has received. If a suitable match is found, the Transaction Engine generates a single-use identifier and transmits the identifier to all of the devices. In addition, the Transaction Engine aggregates the payment amounts received from the Customer Devices and transmits this total payment amount to the Merchant Device. All of the customers and the merchant users of the devices may verbally confirm that the single-identifier number is the same number and, if they wish to confirm the transaction, take an affirmative action on their devices, such as pressing a software button. Based on the affirmative action, the Transmission Engine generates a single-use token which may contain the amounts of the transactions, the identity of the Payers and the identity of the Payee, as well as any other desired information. This single-use token is used to complete the payment transactions between the Payers and the Merchant and then discarded. This single-use token or “transaction” token will preferably be associated with a permanent token for each Customer that contains the Customer's identification information. Transactions are processed using the permanent token as well as the transaction information contained in the single-use token.

What is claimed is:

1. A portable electronic device comprising:
a. a motion sensor;
b. a storage medium for capturing motion data provided by said motion sensor;
c. a static identifier;
d. a processing means for combining said motion data and said static identifier into a value;
e. a means for transmitting said value.

2. The device according to claim 1 wherein the static identifier comprises a value generated by a subscriber identity module.

3. The device according to claim 1 wherein the motion sensor comprises an accelerometer.

4. The device according to claim 3 wherein the motion data comprises numeric values associated with the amplitude and wavelength of motions detected by the accelerometer.

5. A method for generating a personal identifier or password comprising:
a. moving an accelerometer;
b. capturing movement data from the accelerometer; and
c. combining said movement data with a static identifier to generate a combined data value, wherein said combined data value serves as a personal identifier or password.

6. The portable electronic device of claim 1, wherein the portable electronic device comprises an electronic wallet, and wherein the electronic wallet comprises:
a. wallet invocation means responsive to an external trigger originating externally from the wallet;
b. user authentication means for authenticating a user of the electronic wallet upon invocation of the wallet in response to the external trigger, said user authentication means comprising:
i. a first value comprising a device-specific static identifier; and
ii. a second value comprising data generated by an accelerometer in the mobile device; and
c. means for returning card information stored in the wallet for automatic population of a form specified by the external trigger.

7. A method according to claim 5, said method comprising:
a. receiving a first set of physical movement data of a mobile device, the first set of data acquired while a the user supports the mobile device;
b. providing static identifier data;
c. combining said first set of physical movement data with said static identifier data to provide a combined data value;
d. comparing, using a processor, the combined data value with a stored data set; and
e. performing an action based on the comparison.

8. The portable electronic device of claim 1, wherein the portable electronic device comprises a payment processing system, said payment processing system comprising:
a. a first mobile device comprising an accelerometer for generating and transmitting a single-use identifier number; wherein said first device further comprises a payment means;
b. a second device for receiving data including said single-use identifier; wherein said second device comprises a deposit means;
wherein said first and second devices each communicate with a payment processing device; and
c. said payment processing device comprises a means for matching said payment means with said deposit means.

9. The payment processing system of claim 8 wherein the payment means comprises a software application that comprises a payment account selection means and a payment amount selection means.

10. The portable electronic device of claim 1, wherein the portable electronic device comprises a point-of-sale system, the point-of-sale system comprising:
a. a means for detecting the presence of a customer;
b. a mobile device comprising an accelerometer and a means for transmitting information;
c. a point-of-sale terminal; and
d. a pre-existing customer payment account;
wherein said customer moves said mobile device in a pre-defined way in order to confirm a sales transaction.

11. The point-of-sale system of claim 10 wherein the means for detecting the presence of the customer comprises information from a gps, a wifi, a camera, or a scanner.

12. The portable electronic device of claim 1, wherein the portable electronic device comprises a system for transferring value, said system for transferring value comprising:
a. a first accelerometer-containing device;
b. a second device optionally containing an accelerometer;
c. a unique single-use identifier;
d. a transaction processor;
e. a payment account;
f. a deposit account;
wherein said first device generates a unique single-use identifier and broadcasts said identifier; said second device receives said identifier; said first and second devices transmit said identifier; said transaction processor receives said identifier from both first and second devices; and said payment processor transfers value from said payment account to said deposit account.

13. The portable electronic device of claim 1, wherein the portable electronic device comprises a system for transferring value, said system for transferring value comprising:
a. one or more first accelerometer-containing devices;
b. a second device optionally containing an accelerometer;
c. a unique single-use identifier;
d. a transaction processor;
e. a single-use token;
f. one or more payer accounts;
g. one or more payee accounts;
wherein said first devices generate first movement data; said second device generates second movement data; said first and second movement data is received by said transaction processor; said transaction processor generates said single-use identifier and transmits it to first and second devices; said transaction processor generates said single-use token; and said transaction processor uses said single-use token to initiate the transfer of value from said one or more payer accounts to said one or more payee accounts.

14. The portable electronic device of claim 1, wherein the portable electronic device comprises a remote door opener, the remote door opener comprising:
a. a portable electronic device according to claim 1;
b. a means for receiving said value according to claim 1;
c. a means for comparing said value with a stored set of values;
d. a means for opening a door based on the comparison.

15. A remote door opener according to claim 14, wherein the motion data captured by the portable electronic device is data generated by the motion of a car.

16. The portable electronic device of claim 1, wherein the portable electronic device comprises a mobile device comprising an accelerometer and wherein movement of the accelerometer is used for confirmation.

17. The portable electronic device of claim 1, wherein the portable electronic device comprises a mobile device comprising an accelerometer and wherein movement of the accelerometer is used to authenticate.

18. The portable electronic device of claim 1, wherein the portable electronic device comprises a mobile device comprising an accelerometer and wherein movement of the accelerometer is used directly or indirectly to generate a single-use credential, single-use password or single-use personal identification number.

19. The portable electronic device of claim 1, wherein the portable electronic device comprises a mobile device comprising an accelerometer and wherein movement of the accelerometer is used to indicate the need for a token, password or personal identification number from a remote system.

20. The portable electronic device of claim 1, wherein the portable electronic device comprises a mobile device comprising an accelerometer and wherein different pre-defined movements are associated with different outcomes.

21. A device according to claim 20 wherein the outcomes are selected from the group consisting of placing a bet, opening a door, authenticating a transaction, initiating an action, and launching a program.
